(19) United States
(12) Patent Application Publication
(10) Pub. No.: US 2005/0203967 A1
(43) Pub. Date: Sep. 15, 2005

(54) Process management apparatus, process editing apparatus, process management method, and process editing method

(76) Inventor: Yoshiro Matsui, Saitama (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/068,226

(22) Filed: Mar. 1, 2005

(30) Foreign Application Priority Data
Mar. 2, 2004 (JP) 2004-057681
Feb. 23, 2005 (JP) 2005-047792

(51) Int. Cl. G06F 17/30

(52) U.S. Cl. 707/202

(57) ABSTRACT

A process management apparatus capable of editing a process is disclosed that includes a log recording part recording the result of execution of the process as a log and a process definition entering part entering a process definition reconfigured based on the log, the process definition being the template of the process.

### BACKGROUND OF THE INVENTION

1. Field of the Invention

The present invention relates to a process management apparatus, a process editing apparatus, a process management method, a process editing method, and recording media on which programs for causing a computer to execute such methods are recorded.

2. Description of the Related Art

In these years, a workflow system has become well known that manages and automates a flow of documents or information from one person to another, when multiple persons work via a network, so as to facilitate their work. Such a workflow system is disclosed, for instance, in Haruo Hayami; “Expanding Workflow Management System: 1,” IPSJ (Information Processing Society of Japan) Magazine, Vol. 39, No. 11, pp. 1160-1165 (1998); Haruo Hayami, Toshiaki Sakaguchi, and Ryoichi Shibuya; “Expanding Workflow Management System: 2,” IPSJ Magazine, Vol. 39, No. 12, pp. 1258-1263 (1998); and Haruo Hayami, Ryoichi Shibuya, Takao Suzuki, Junichi Ikoma, Yosuke Terashita, Naoki Ueno, Satoshi Kaneko, and Kiyoshi Hayashi; “Expanding Workflow Management System: 3,” IPSJ Magazine, Vol. 40, No. 5, pp. 507-513 (1999).

A workflow system in which a workflow participant can review and edit (or change) a workflow process after executing the process is also possible.

However, in such a workflow system, workflow participants can change processes after their execution. Accordingly, there exist numerous processes for tasks of the same kind. This causes a problem in that it is difficult to create a process definition, which is a process template, reusing the processes.

Further, this causes a problem in that it is difficult to provide an optimized process definition to a user.

### SUMMARY OF THE INVENTION

Accordingly, it is a general object of the present invention to provide a process management apparatus, a process editing apparatus, a process management method, and a process editing method in which the above-described disadvantage is eliminated.

A more specific object of the present invention is to provide a process management apparatus, a process editing apparatus, a process management method, and a process editing method that can provide an optimized process definition.

Another more specific object of the present invention is to provide recording media on which programs for causing a computer to execute such methods are recorded.

One or more of the above objects of the present invention are achieved by a process management apparatus capable of editing a process, including a log recording part configured to record a result of execution of the process as a log; and a process definition entering part configured to enter a process definition reconfigured based on the log, the process definition being a template of the process.

One or more of the above objects of the present invention are also achieved by a process management apparatus capable of performing process editing, including a constraint information extracting part configured to extract constraint information from a plurality of process definitions, the process definitions being templates of corresponding processes, the constraint information being related to an order relation between individual jobs of each of the processes; and a process definition entering part configured to enter one of the process definitions reconfigured based on the extracted constraint information.

One or more of the above objects of the present invention are also achieved by an apparatus for editing a process, including a reconfiguration part configured to reconfigure a process definition based on a result of execution of the process, the process definition being a template of the process.

One or more of the above objects of the present invention are also achieved by an apparatus for performing process editing, including a constraint information extracting part configured to extract constraint information from a plurality of process definitions, the process definitions being templates of corresponding processes, the constraint information being related to an order relation between individual jobs of each of the processes; and a reconfiguration part configured to reconfigure the process definitions based on the extracted constraint information.

One or more of the above objects of the present invention are also achieved by a computer-readable recording medium storing a program for causing a computer to execute a method of managing a process, the method including the steps of (a) recording a result of execution of the process as a log; and (b) entering a process definition reconfigured based on the log, the process definition being a template of the process.

One or more of the above objects of the present invention are also achieved by a computer-readable recording medium storing a program for causing a computer to execute a process management method, the process management method including the steps of (a) extracting constraint information from a plurality of process definitions, the process definitions being templates of corresponding processes, the constraint information being related to an order relation between individual jobs of each of the processes; and (b) entering one of the process definitions reconfigured based on the extracted constraint information.

One or more of the above objects of the present invention are also achieved by a computer-readable recording medium storing a program for causing a computer to execute a method of editing a process, the method including the step of (a) reconfiguring a process definition based on a result of execution of the process, the process definition being a template of the process.

One or more of the above objects of the present invention are also achieved by a computer-readable recording medium storing a program for causing a computer to execute a process editing method, the process editing method including the steps of (a) extracting constraint information from a plurality of process definitions, the process definitions being templates of corresponding processes, the constraint information being related to an order relation between individual jobs of each of the processes; and (b) reconfiguring the process definitions based on the extracted constraint information.

One or more of the above objects of the present invention are also achieved by a method of managing a process, the method including the steps of (a) recording a result of execution of the process as a log; and (b) entering a process definition reconfigured based on the log, the process definition being a template of the process.

One or more of the above objects of the present invention are also achieved by a process management method, including the steps of (a) extracting constraint information from a plurality of process definitions, the process definitions being templates of corresponding processes, the constraint information being related to an order relation between individual jobs of each of the processes; and (b) entering one of the process definitions reconfigured based on the extracted constraint information.

One or more of the above objects of the present invention are also achieved by a method of editing a process, including the step of reconfiguring a process definition based on a result of execution of the process, the process definition being a template of the process.

One or more of the above objects of the present invention are also achieved by a process editing method, including the steps of (a) extracting constraint information from a plurality of process definitions, the process definitions being templates of corresponding processes, the constraint information being related to an order relation between individual jobs of each of the processes; and (b) reconfiguring the process definitions based on the extracted constraint information.

According to the present invention, an optimized process definition can be provided.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram illustrating a hardware configuration of a server according to a first embodiment of the present invention;

FIG. 2 is a block diagram illustrating a hardware configuration of a client according to the first embodiment of the present invention;

FIG. 3 is a schematic diagram for illustrating the terms employed in this specification;

FIG. 4 is a schematic diagram illustrating a software configuration according to the first embodiment of the present invention;

FIG. 5 is a sequence diagram illustrating execution of a workflow-related process according to the first embodiment of the present invention;

FIG. 6 is a sequence diagram illustrating reconfiguration of a process definition according to the first embodiment of the present invention;

FIG. 7 is a diagram illustrating a flow defined by a base process definition according to the first embodiment of the present invention;

FIG. 8 illustrates a process execution result Gantt chart according to the first embodiment of the present invention;

FIG. 9 illustrates an activity order relation table created based on the base flow of FIG. 7 according to the first embodiment of the present invention;

FIG. 10 illustrates an activity order relation table created based on the process execution result Gantt chart of FIG. 8 according to the first embodiment of the present invention;

FIG. 11 illustrates an activity order relation table created based on the activity order relation tables of FIGS. 9 and 10 according to the first embodiment of the present invention;

FIG. 12 a diagram illustrating the reconfigured flow according to the first embodiment of the present invention;

FIG. 13 illustrates another process execution result Gantt chart according to the first embodiment of the present invention;

FIG. 14 illustrates another activity order relation table created based on the base flow of FIG. 7 according to the first embodiment of the present invention;

FIG. 15 illustrates an activity order relation table created based on the process execution result Gantt chart of FIG. 13 according to the first embodiment of the present invention;

FIG. 16 illustrates an activity order relation table created based on the activity order relation tables of FIGS. 14 and 15 according to the first embodiment of the present invention;

FIG. 17 is a diagram illustrating the reconfigured flow according to the first embodiment of the present invention;

FIG. 18 is a diagram illustrating a flow defined in a process definition according to the first embodiment of the present invention;

FIG. 19 illustrates an activity order relation table created based on the flow of FIG. 18 according to the first embodiment of the present invention;

FIG. 20 is a diagram illustrating a flow defined in another process definition according to the first embodiment of the present invention;

FIG. 21 illustrates an activity order relation table created based on the flow of FIG. 20 according to the first embodiment of the present invention;

FIG. 22 illustrates an activity order relation table created based on the activity order relation tables of FIGS. 19 and 21 according to the first embodiment of the present invention;

FIG. 23 is a diagram illustrating the reconfigured flow according to the first embodiment of the present invention;

FIG. 24 is a diagram illustrating a GUI in a process definition editing tool according to the first embodiment of the present invention;

FIG. 25 is a schematic diagram illustrating a software configuration according to a second embodiment of the present invention;

FIGS. 26A and 26B illustrate examples of an inter-product relationship table according to the second embodiment of the present invention;

FIGS. 27A and 27B illustrate examples of an activity-product relationship table according to the second embodiment of the present invention;

FIG. 28 illustrates an example of the inter-activity relationship table according to the second embodiment of the present invention;

FIG. 29 is a sequence diagram illustrating reconfiguration of a process definition according to the second embodiment of the present invention;

FIG. 30 is a flowchart for illustrating reconfiguration of a process definition based on the relationship between activities according to the second embodiment of the present invention;

FIG. 31 illustrates another example of the inter-product relationship table according to the second embodiment of the present invention;

FIG. 32 illustrates another example of the activity-product relationship table according to the second embodiment of the present invention;

FIG. 33 illustrates another example of the inter-activity relationship table according to the second embodiment of the present invention;

FIG. 34 illustrates an activity order relation table created based on the activity order relation table of FIG. 22 and the inter-activity relationship table of FIG. 33 according to the second embodiment of the present invention; and

FIG. 35 is a diagram illustrating the reconfigured flow according to the second embodiment of the present invention.

### DETAILED DESCRIPTION OF THE PREFERRED EMBODIMENTS

A description is given below, with reference to the accompanying drawings, of embodiments of the present invention.

### First Embodiment

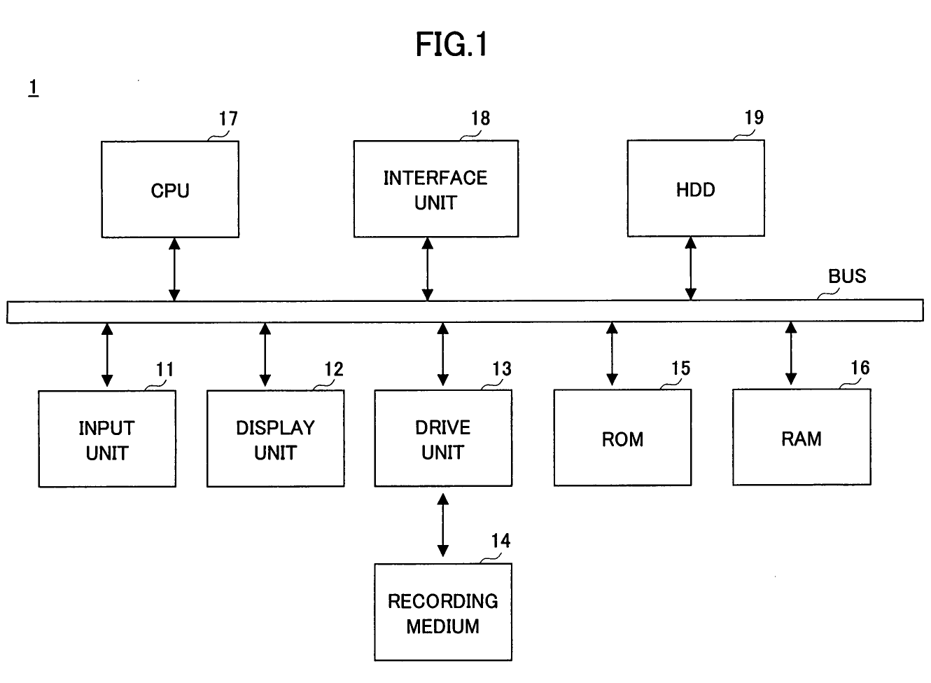

First, a description is given, with reference to FIG. 1, of a hardware configuration of a server 1 according to a first embodiment of the present invention. FIG. 1 is a block diagram illustrating a hardware configuration of the server 1.

The hardware configuration of the server 1 illustrated in FIG. 1 includes an input unit 11, a display unit 12, a drive unit 13, a ROM (Read-Only Memory) 15, a RAM (Random Access Memory) 16, a CPU (Central Processing Unit) 17, an interface unit 18, and an HDD (Hard Disk Drive) 19, which are interconnected through a bus.

The input unit 11 includes a keyboard and a mouse operated by a user of the server 1. The input unit 11 is used to input various operational signals to the server 1. The display unit 12 includes a display used by the user of the server 1, and displays a variety of information items. The interface unit 18 connects the server 1 to a network or the like.

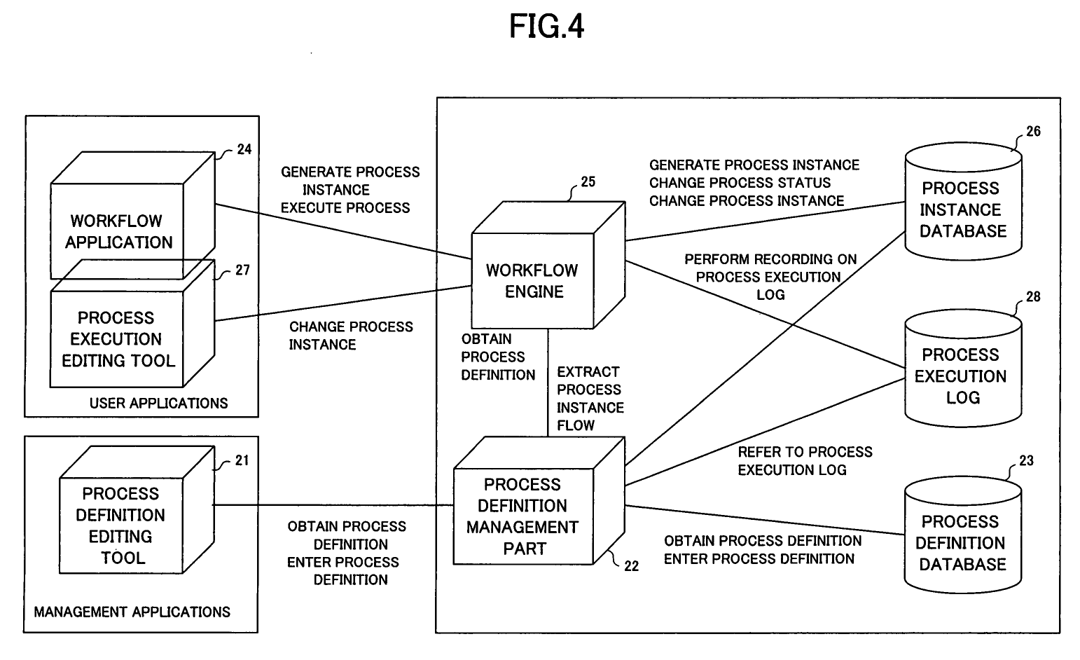

A below-described process definition management part 22, workflow engine 25, process definition database 23, process execution log 28, and process instance database 26 (FIG. 4), which are programs corresponding to software, are provided to the server 1 by a recording medium 14 such as a CD-ROM, or are downloaded to the server 1 through the network, for instance. The recording medium 14 is set in the drive unit 13, so that the programs are installed in the HDD 19 through the drive unit 13 from the recording medium 14.

The ROM 15 stores data. The RAM 16 stores the program read out from the HDD 19 when the server 1 is started. The CPU 17 performs processing in accordance with the program stored in the RAM 16. The HDD 19 stores programs and, for instance, below-described process definitions and activity order relation table.

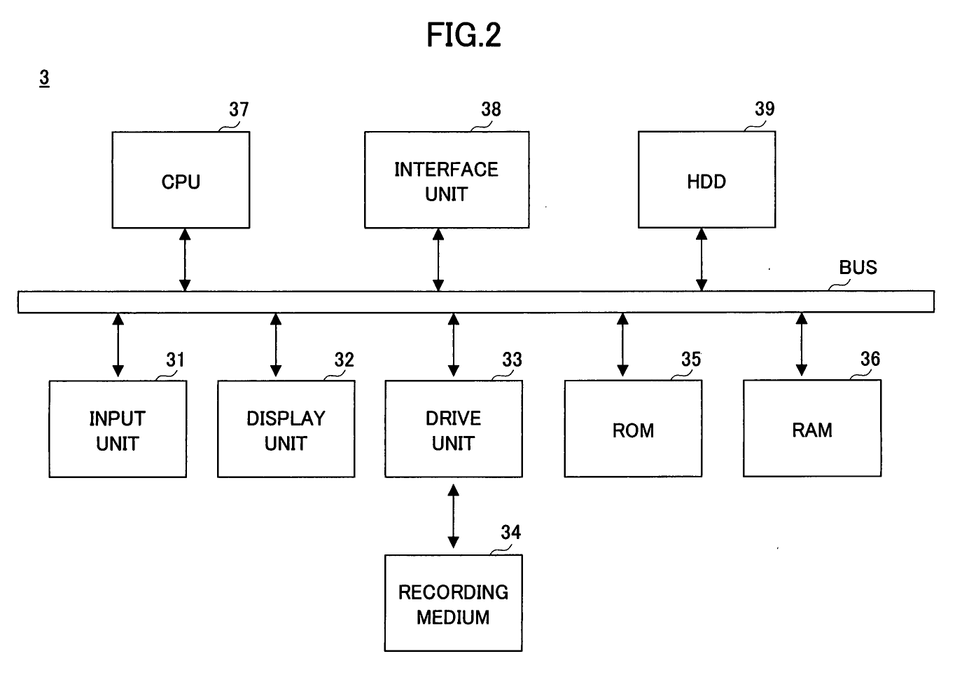

Next, a description is given, with reference to FIG. 2, of a hardware configuration of a client 3 according to the first embodiment of the present invention. FIG. 2 is a block diagram illustrating a hardware configuration of the client 3.

The hardware configuration of the client 3 illustrated in FIG. 2 includes an input unit 31, a display unit 32, a drive unit 33, a ROM 35, a RAM 36, a CPU 37, an interface unit 38, and an HDD 39, which are interconnected through a bus.

The input unit 31 includes a keyboard and a mouse operated by a user of the client 3. The input unit 31 is used to input various operational signals to the client 3. The display unit 32 includes a display used by the user of the client 3, and displays a variety of information items. The interface unit 38 connects the client 3 to the network.

Programs corresponding to user applications including a below-described workflow application 24 and process execution editing tool 27 (FIG. 4) and/or programs corresponding to management applications including a below-described process definition editing tool 21 (FIG. 4) are provided to the client 3 by a recording medium 34 such as a CD-ROM, or are downloaded to the client 3 through the network, for instance. The recording medium 34 is set in the drive unit 33, so that the programs are installed in the HDD 39 through the drive unit 33 from the recording medium 34.

The ROM 35 stores data. The RAM 36 stores the program read out from the HDD 39 when the client 3 is started. The CPU 37 performs processing in accordance with the program stored in the RAM 36. Below-described process instances and process definitions that the client 3 obtains from the server 1 are stored temporarily in, for instance, the RAM 36.

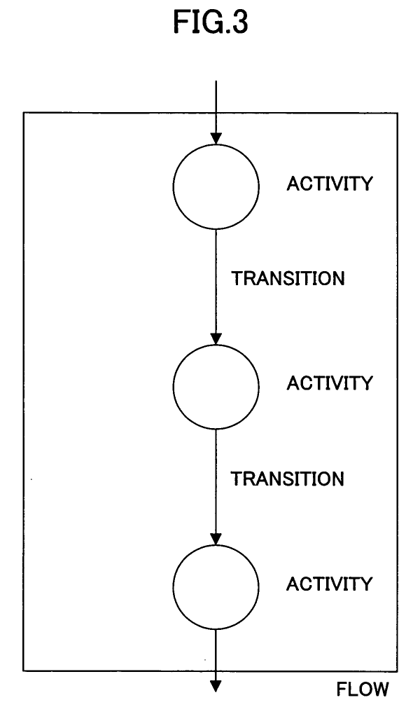

Next, a description is given, with reference to FIG. 3, of terms employed in this specification. FIG. 3 is a schematic diagram for illustrating the terms employed in this specification.

In this specification, a process refers to a processing flow for carrying out a task. An activity refers to each of the jobs forming the process. The activity has states such as ACTIVATED, COMPLETED, and WAITING. For instance, a below-described workflow system composed of software (hereinafter, also simply referred to as “workflow system”) expresses the progress of the process by the transition of these states. A transition defines the order of execution of activities. The transition also has a condition (state), and the workflow system determines the state transition condition of an activity to connect based on the condition.

A flow is a flowchart of processing expressed by activities and transitions. A process definition is a process template, and defines the flow of a process before execution. A process instance flow is the flow of a process in execution (that is being executed).

A process instance is a substantiated process definition, and includes the actual contents of a task. The above-described process instance flow is the flow definition of a process instance. Normally, the process instance flow is equal to its base process definition.

However, as described below, the process instance flow and the process definition are treated as different entities and are separately operable in this workflow system. Accordingly, in this workflow system, a change in the process instance flow is prevented from being reflected in its base process definition, and a change in the process definition is also prevented from being reflected in a process that has already been converted into an instance.

The necessity of changing the flow of a process in execution, that is, a process instance flow, includes the following.

(a) In general, in intellectual operations whose execution requires advanced judgments, such as sales and production activities, the actual operations are often implemented changing processes according to circumstances although the basic processes are determined. Accordingly, it is possible to proceed with operations with efficiency by dynamically generating an optimal process for each operation in a workflow system.

(b) It is difficult to apply the conventional workflow system, where basic processes must be followed, to such intellectual operations as described above.

(c) In a workflow system in which a process (or the flow thereof) is changeable at the time of its execution, it is possible to proceed with an operation, tailoring the process (or the flow thereof) to the individual operation by changing the process in line with the actual operation according to circumstances at the time of execution of the process. This enables a workflow system to be applied to intellectual operations to which it is difficult to apply the conventional workflow system. Further, by reusing a process optimized to an individual process, it is possible to share the best practice (for instance, an optimized process definition) between users.

Next, a description is given, with reference to FIG. 4, of a configuration of software installed in the server 1 and the client 3 according to the first embodiment of the present invention. FIG. 4 is a schematic diagram illustrating a software configuration according to the first embodiment of the present invention.

The software configuration illustrated in FIG. 4 includes the process definition editing tool 21, the workflow application 24, the process execution editing tool 27, the process definition management part 22, the workflow engine 25, the process definition database 23, the process instance database 26, and the process execution log 28.

The process definition editing tool 21 edits a process definition. The process definition editing tool 21 enters a process definition in the process definition database 23 and obtains a process definition from the process definition database 23 through the process definition management part 22. Further, the process definition editing tool 21 extracts a process instance flow from the process instance database 26 through the process definition management part 22. The process definition editing tool 21 also obtains the execution result of a process from the process execution log 28 through the process definition management part 22, and edits or reconfigures, for instance, a process instance flow or the base process definition thereof based on the obtained execution result of the process. Then, the process definition editing tool 21 enters the edited or reconfigured process instance flow or the base process definition thereof in the process definition database 23 through the process definition management part 22 as a process definition.

Alternatively, the process definition management part 22 may reconfigure a process definition based on, for instance, a process instance flow and a below-described process execution result Gantt chart created based on a log recorded in the process execution log 28. The same holds true for the following.

The process definition editing tool 21 also displays a process execution result Gantt chart provided from, for instance, the process definition management part 22, thereby providing the process execution result Gantt chart to a user. The user, for instance, edits a flow, referring to the displayed process execution result Gantt chart, and reconfigures a process definition.

The process definition management part 22 manages process definitions stored in the process definition database 23. In response to a request from the process definition editing tool 21, the process definition management part 22 obtains a corresponding process definition from the process definition database 23, or enters a corresponding process definition in the process definition database 23.

Further, the process definition management part 22 extracts a process instance flow from the process instance database 26 and provides the extracted process instance flow to the process definition editing tool 21 based on a request therefrom. The process definition management part 22 also refers to the process execution log 28 based on a request from the process definition editing tool 21.

Further, the process definition management part 22, for instance, creates a process execution result Gantt chart based on the result of the reference to the process execution log 28, and provides the created process execution result Gantt chart to the process definition editing tool 21. The process execution result Gantt chart may be created and displayed in the process definition editing tool 21 receiving the result of the reference to the process execution log 28. The same holds true for the following.

The process definition database 23 stores process definitions.

The workflow application 24 executes activities. Through the workflow engine 25, the workflow application 24 obtains the process information and the process status of a corresponding process instance stored in the process instance database 26, and changes the process status.

In response to a request from the workflow application 24, the workflow engine 25 obtains a corresponding process definition from the process instance database 23 through the process definition management part 22, converts a process into an instance based on the obtained process definition, and stores the process-converted instance in the process instance database 26. Further, based on a request from the workflow application 24, the workflow engine 25 obtains the process information and the process status of a corresponding process instance from the process instance database 26, or changes the process status of a corresponding process instance stored in the process instance database 26.

Further, the workflow engine 25 extracts a process instance flow from the process instance database 26 in response to a request from the process execution editing tool 27. The workflow engine 25 also updates a process instance flow stored in the process instance database 26 in response to a request from the process execution editing tool 27. The updating of the process instance flow includes suspension of an activity, advance execution of an activity, and addition of an activity.

Further, the workflow engine 25 records the execution result of a process (or an activity) in the process execution log 28 in response to a request to execute the process (or activity) from the workflow application 24.

The process instance database 26 stores process instances.

The process execution editing tool 27 edits a process instance flow. The process execution editing tool 27 obtains a process instance flow from the process instance database 26 through the workflow engine 25, and edits the obtained process instance flow. The process execution editing tool 27 stores the edited process instance flow in the process instance database 26 through the workflow engine 25, thereby updating the process instance flow.

The process execution log 28 is a log in which the execution result of a process (or an activity) is recorded. For instance, execution results recorded in the process execution log 28 include the execution time information of each activity of a process at the time of executing the process, such as a time at which the status of the activity is changed, the starting time of the activity, and the end time of the activity.

As described above, for instance, the process definition editing tool 21 included in the management applications and/or the workflow application 24 and the process execution editing tool 27 included in the user applications are installed in the client 3, and the process definition management part 22, the workflow engine 25, the process instance database 26, the process execution log 28, and the process definition database 23 are installed in the server 1. Further, the process definition editing tool 21, the workflow application 24, the process execution editing tool 27, the process definition management part 22, the workflow engine 25, the process instance database 26, the process execution log 28, and the process definition database 23 may be installed as Web services. In this configuration, communications are performed between the client 3 and the server 1 in accordance with SOAP (Simple Object Access Protocol) based on XML (extensible Markup Language) or HTTP (HyperText Transfer Protocol).

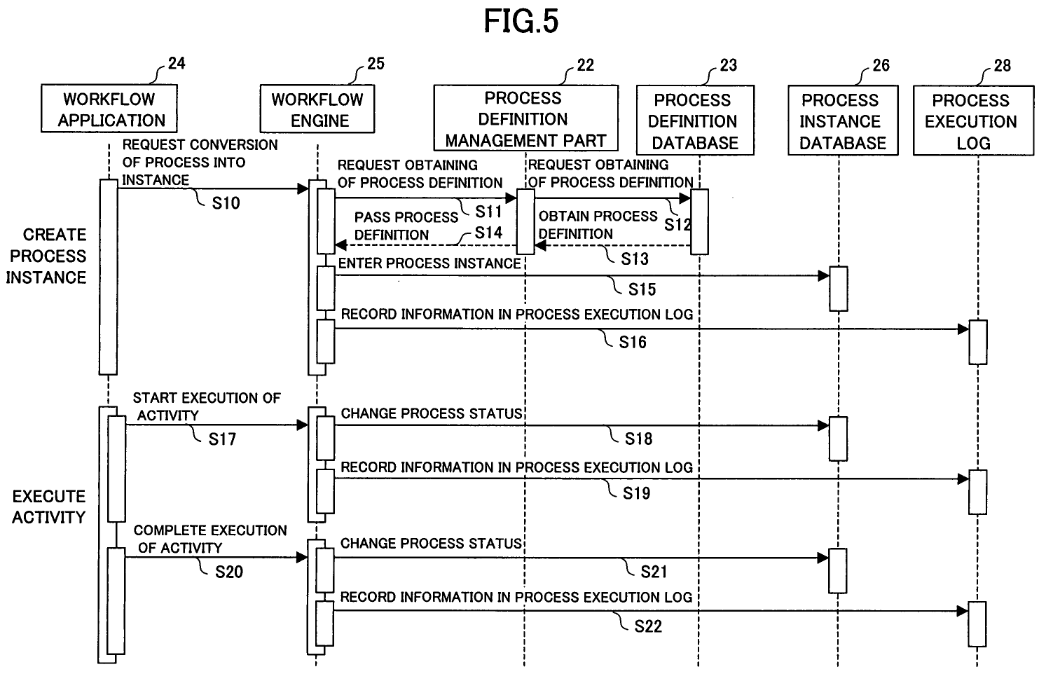

A description is given below, with reference to FIG. 5, of execution of a workflow-related process. FIG. 5 is a sequence diagram illustrating execution of a workflow-related process.

First, in step S10, the workflow application 24 transmits a request to convert a process into an instance to the workflow engine 25 based on a request from a workflow participant (hereinafter, also simply referred to as “user”).

In step S11, receiving the request from the workflow application 24, the workflow engine 25 requests the process definition management part 22 to obtain a corresponding process definition.

In step S12, receiving the request from the workflow engine 25, the process definition management part 22 requests the process definition database 23 to obtain the corresponding process definition, and in step S13, the process definition management part 22 receives the process definition.

In step S14, the process definition management part 22 passes the obtained process definition to the requesting workflow engine 25.

In step S15, receiving the process definition, the workflow engine 25 converts the process into an instance based on the process definition, and enters the process-converted instance (process instance) in the process instance database 26.

In step S16, entering the process instance in the process instance database 26, the workflow engine 25 records, for instance, the contents and the entry date and time of the entered process instance in the process execution log 28.

Next, in step S17, the workflow application 24 transmits a notification of the start of execution of an activity to the workflow engine 25 in response to a request from the user.

In step S18, receiving the notification from the workflow application 24, the workflow engine 25 changes the status of a corresponding process instance flow (process status) stored in the process instance database 26 to, for instance, STARTED (ACTIVATED).

Changing the process status, in step S19, the workflow engine 25 records, for instance, the contents of the changed process status and the date and time of the change in the process execution log 28.

In step S20, the workflow application 24 executes the activity started in step S17, and when the execution of the activity is completed, the workflow application 24 transmits a notification of the completion of the execution of the activity to the workflow engine 25.

In step S21, receiving the notification from the workflow application 24, the workflow engine 25 changes the status of the corresponding process instance flow (process status) stored in the process instance database 26 to, for instance, COMPLETED.

Changing the process status, in step S22, the workflow engine 25 records, for instance, the contents of the changed process status and the date and time of the change in the process execution log 28.

As illustrated in FIG. 5, by storing information such as execution time information activity by activity as a log at the time of process execution, it is possible to reconfigure a process definition based on the information of the log.

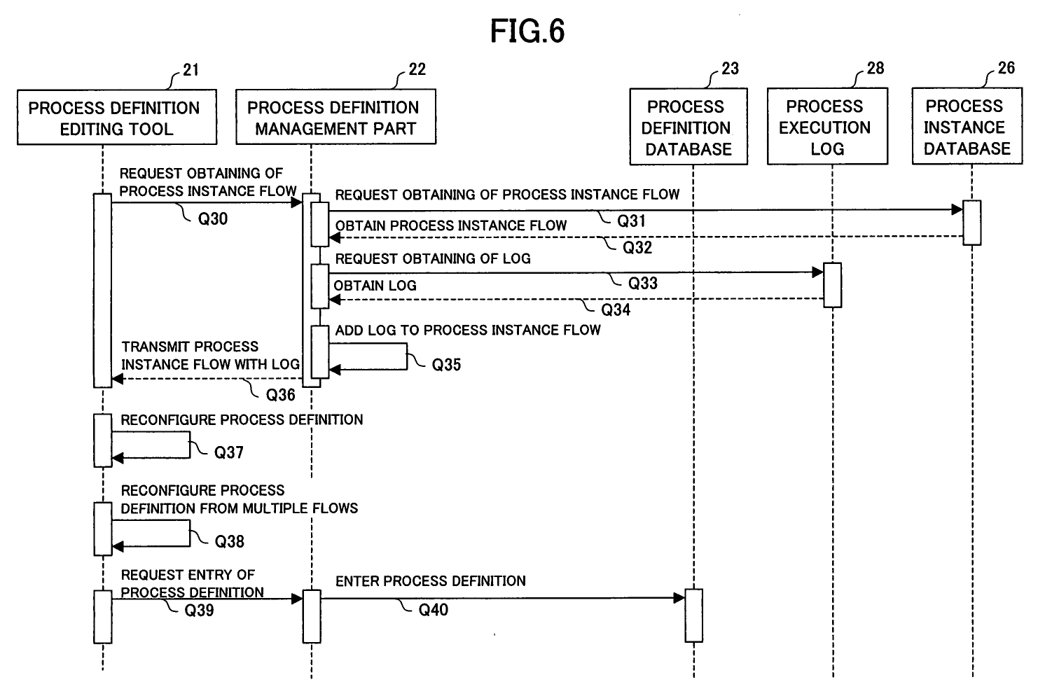

A description is given below, with reference to FIG. 6, of reconfiguration of a process definition according to the first embodiment. FIG. 6 is a sequence diagram illustrating reconfiguration of a process definition.

First, in step S30, the process definition editing tool 21 transmits a request to obtain a process instance flow to the process definition management part 22 based on a request from a user.

In step S31, receiving the request from the process definition editing tool 21, the process definition management part 22 requests the process instance database 26 to obtain the process instance flow, and in step S32, the process definition management part 22 obtains the process instance flow.

In step S33, the process definition management part 22 requests the process execution log 28 to obtain a log, and in step S34, the process definition management part 22 obtains the log.

Obtaining the process instance flow and the log, in step S35, the process definition management part 22 adds the log to the process instance flow, and in step S36, the process definition management part 22 transmits the process instance flow with the log to the process definition editing tool 21.

In step S37, the process definition editing tool 21 reconfigures a process definition based on the process instance flow to which the log is added. Alternatively, in the case where multiple process instance flows are obtained and transmitted, in step S38, the process definition editing tool 21 reconfigures a process definition based on the multiple process instance flows. As described below, the process definition editing tool 21 may edit a process flow and reconfigure a process definition based on the process instance flow to which the log is added and, for instance, a constraint on the order relation between activities (for instance, an activity order relation table) obtained from the server 1. Alternatively, the process definition editing tool 21 may edit a process flow and reconfigure a process definition based on the multiple process instance flows and, for instance, a constraint on the order relation between activities (for instance, an activity order relation table) obtained from the server 1. It is sufficient to perform either step S37 or step S38.

In step S39, the process definition editing tool 21 transmits a request to enter the reconfigured process definition to the process definition management part 22, the request including the reconfigured process definition.

In step S40, receiving the request from the process definition editing tool 21, the process definition management part 22 enters the reconfigured process definition in the process definition database 23.

By performing an operation as illustrated in FIG. 6, it is possible to reconfigure a process definition and enter the reconfigured process definition.

For simplification, the below description of this embodiment is given, unless otherwise specified, based on the assumption that a process definition is reconfigured by the process definition management part 22, which does not limit the implementation of the present invention.

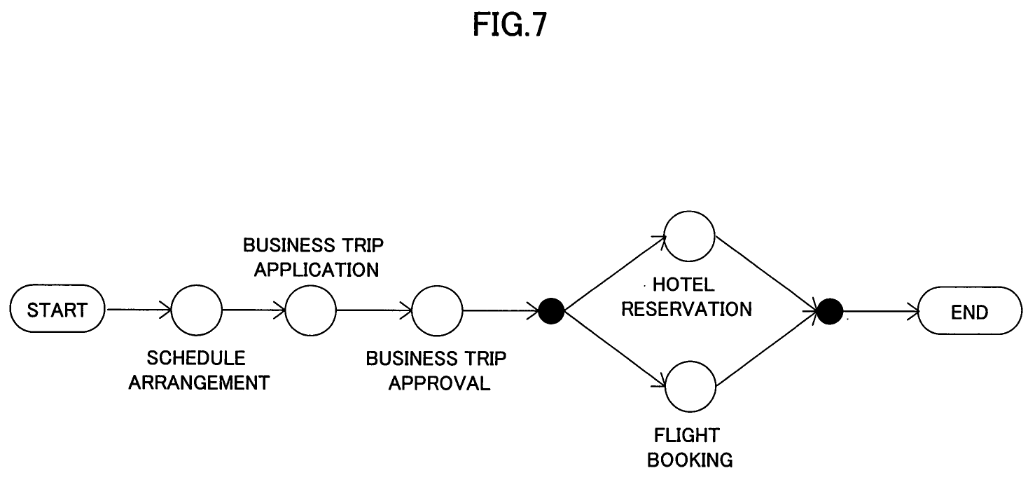

A description is given below, with reference to FIGS. 7 through 12, of reconfiguration of a process definition. FIG. 7 is a diagram illustrating a (base) flow defined by a base process definition.

According to the flow of FIG. 7, after arranging a schedule, applying for a business trip, and receiving approval of the business trip, hotel reservation and flight booking are performed in parallel.

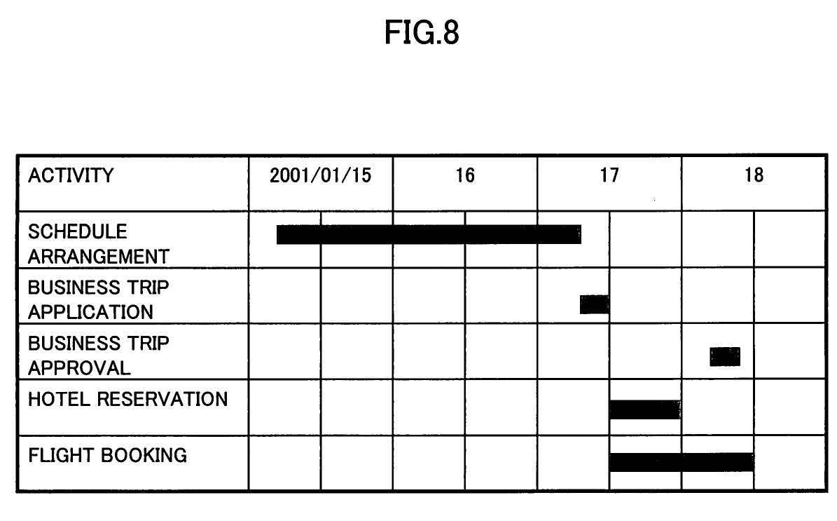

FIG. 8 illustrates a process execution result Gantt chart (a Gantt chart of a process execution result) that the process definition management part 22 creates referring to a log as a result of the actual execution of a process based on the flow illustrated in FIG. 7.

According to the case of FIG. 8, the starting time and the end time of HOTEL RESERVATION are earlier than the starting time and the end time of BUSINESS TRIP APPROVAL. Further, the starting time of HOTEL RESERVATION is the same as the starting time of FLIGHT BOOKING. The starting time of FLIGHT BOOKING is earlier than the starting time of BUSINESS TRIP APPROVAL, and the end time of FLIGHT BOOKING is later than the end time of BUSINESS TRIP APPROVAL.

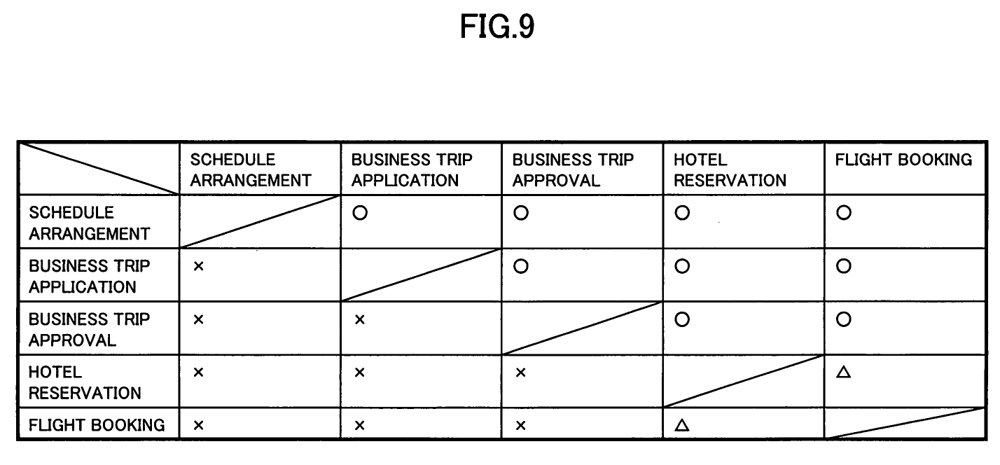

FIG. 9 illustrates an activity order relation table created by the process definition management part 22 based on the flow defined by the base process definition illustrated in FIG. 7.

In the table of FIG. 9, a circle indicates that an activity in the column succeeds an activity in the row, a cross indicates that an activity in the column precedes an activity in the row, and a triangle indicates that there is no order relation between an activity in the column and an activity in the row. The same holds true for the following tables.

The process definition management part 22 can create an activity order relation table as illustrated in FIG. 9 based on a flow defined by a base process definition as illustrated in FIG. 7.

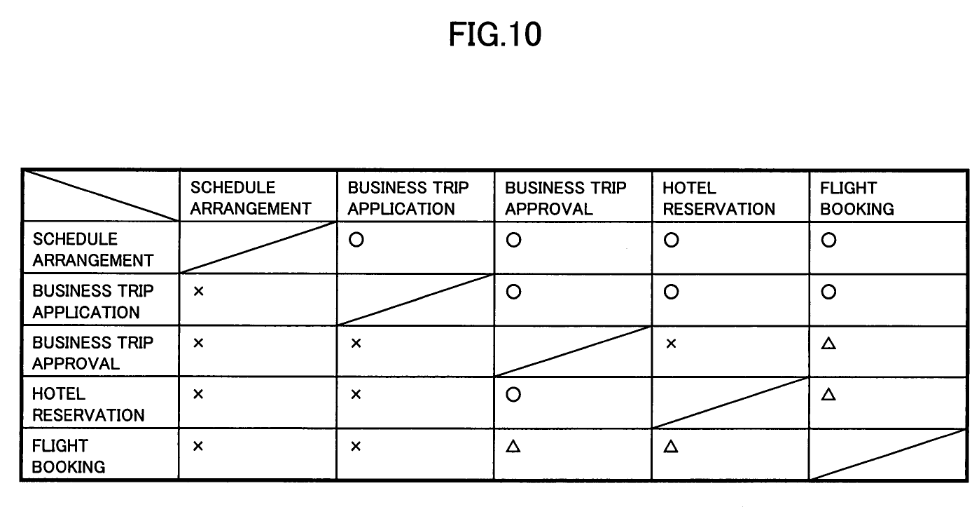

FIG. 10 illustrates an activity order relation table created by the process definition management part 22 based on the process execution result Gantt chart illustrated in FIG. 8.

The comparison between the activity order relation tables of FIGS. 9 and 10 shows that there are changes in the relationship between BUSINESS TRIP APPROVAL and HOTEL RESERVATION and the relationship between BUSINESS TRIP APPROVAL and FLIGHT BOOKING.

The process definition management part 22 can create an activity order relation table as illustrated in FIG. 10 based on a process execution result Gantt chart as illustrated in FIG. 8.

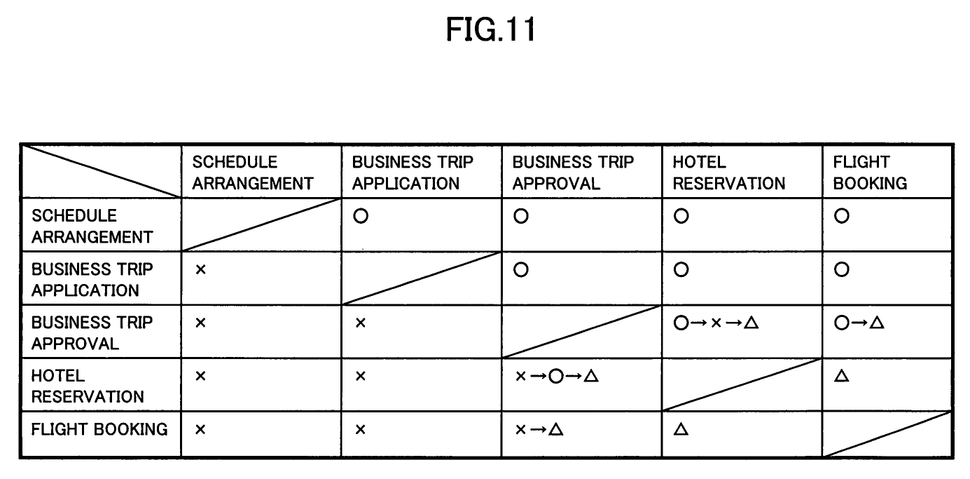

FIG. 11 illustrates an activity order relation table created by the process definition management part 22 based on the activity order relation tables of FIGS. 9 and 10.

The process definition management part 22 compares the activity order relation table of FIG. 9 created based on the flow defined by the base process definition and the activity order relation table of FIG. 10 created based on the process execution result Gantt chart, and if there is a change in any order relation between activities, the process definition management part 22 changes the data on the order relation to NO DEPENDENCY (triangle) as illustrated in FIG. 11.

Based on the created activity order relation table illustrated in FIG. 11, the process definition management part 22 combines activities having no order relation by AND-Split or AND-Join, and connects activities having an order relation with a normal transition, thereby reconfiguring the flow.

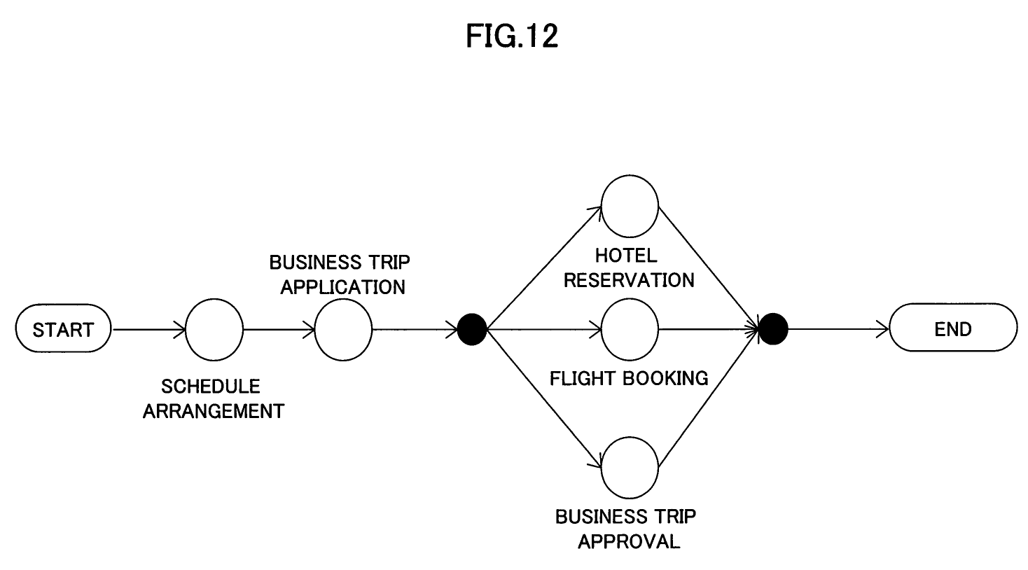

FIG. 12 is a diagram illustrating the reconfigured flow.

For instance, the process definition management part 22 enters a reconfigured flow as illustrated in FIG. 12 in the process definition database 23 as a reconfigured process definition.

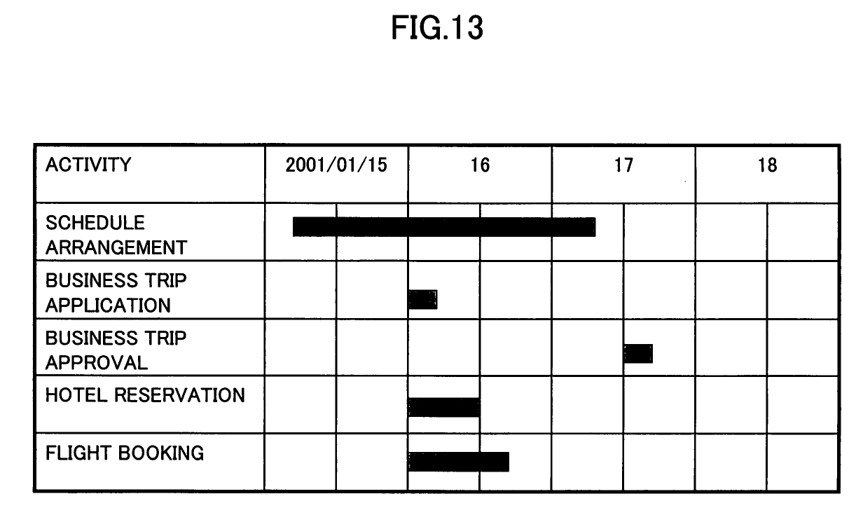

A description is given, with reference to FIGS. 13 through 17, of reconfiguration of a process definition in which a constraint on the order relation between activities is considered. FIG. 13 illustrates another process execution result Gantt chart.

The process definition management part 22 creates the process execution result Gantt chart of FIG. 13, referring to a log, as a result of the actual execution of a process based on the flow illustrated in FIG. 7.

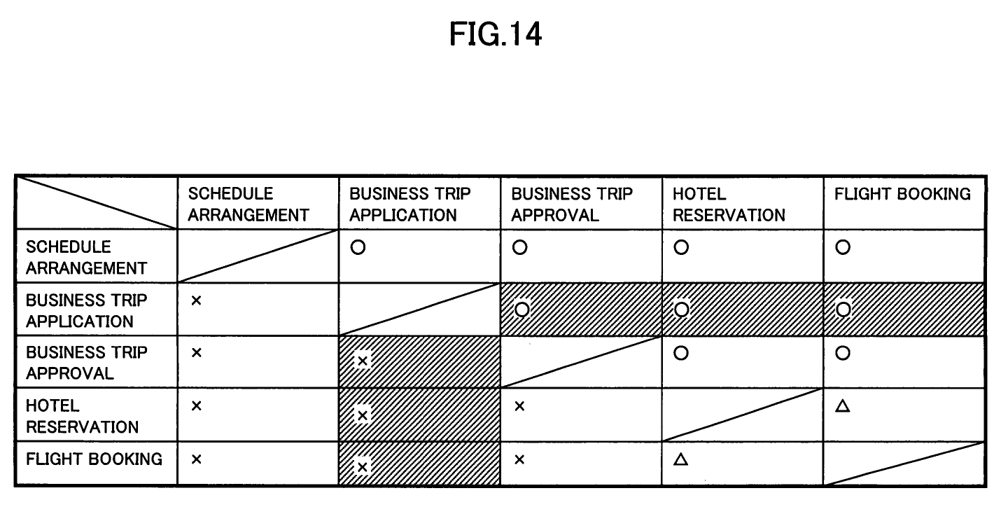

FIG. 14 illustrates an activity order relation table created by the process definition management part 22 based on the flow defined by the base process definition illustrated in FIG. 7.

Compared with the activity order relation table illustrated in FIG. 9, in the activity order relation table of FIG. 14, the order relation between activities on which order relation a constraint is defined in the process definition is indicated by hatching. The constraint is extracted from the process definition. In FIG. 14, the order relation between activities on which order relation a constraint is defined in the process definition is indicated by hatching for simplification of description or for convenience of display to a user. Actually, however, a flag indicating the presence of a constraint on the order relation between activities is stored, together with the value of a circle, triangle, or cross, in the corresponding part. The same holds true for the following.

The process definition management part 22 can create an activity order relation table as illustrated in FIG. 14 based on a flow defined by a base process definition as illustrated in FIG. 7 and a constraint on the order relation between activities.

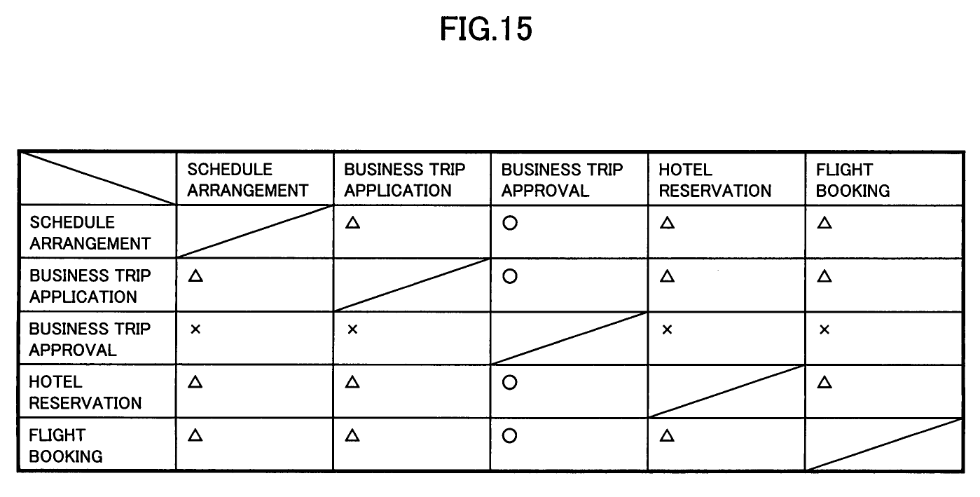

FIG. 15 illustrates an activity order relation table created by the process definition management part 22 based on the process execution result Gantt chart illustrated in FIG. 13.

The comparison between the activity order relation tables of FIGS. 14 and 15 shows that there are changes in the relationship between SCHEDULE ARRANGEMENT and BUSINESS TRIP APPLICATION, the relationship between HOTEL RESERVATION and SCHEDULE ARRANGEMENT, the relationship between SCHEDULE ARRANGEMENT and FLIGHT BOOKING, the relationship between BUSINESS TRIP APPLICATION and HOTEL RESERVATION, the relationship between BUSINESS TRIP APPLICATION and FLIGHT BOOKING, the relationship between BUSINESS TRIP APPROVAL and HOTEL RESERVATION, and the relationship between BUSINESS TRIP APPROVAL and FLIGHT BOOKING.

The process definition management part 22 can create an activity order relation table as illustrated in FIG. 15 based on a process execution result Gantt chart as illustrated in FIG. 13.

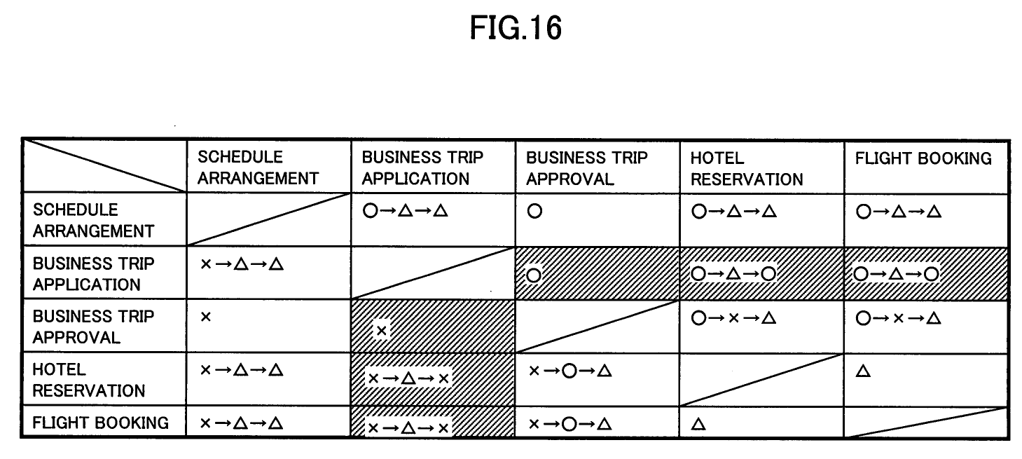

FIG. 16 illustrates an activity order relation table created by the process definition management part 22 based on the activity order relation tables of FIGS. 14 and 15.

The process definition management part 22 compares the activity order relation table of FIG. 14 created based on the flow defined by the base process definition and the activity order relation table of FIG. 15 created based on the process execution result Gantt chart, and if there is a change in any order relation between activities, the process definition management part 22 changes the data on the order relation to NO DEPENDENCY (triangle) as illustrated in FIG. 16. However, with respect to any two activities whose order relation is determined by a constraint, the process definition management part 22 retains their order relation of the flow defined by the base process definition.

Based on the created activity order relation table illustrated in FIG. 16, the process definition management part 22 combines activities having no order relation by AND-Split or AND-Join. However, the process definition management part 22 treats activities as having an order relation if there is indirect dependency between the activities. The process definition management part 22 connects activities having an order relation with a normal transition. Thereby, the process definition management part 22 reconfigures the flow.

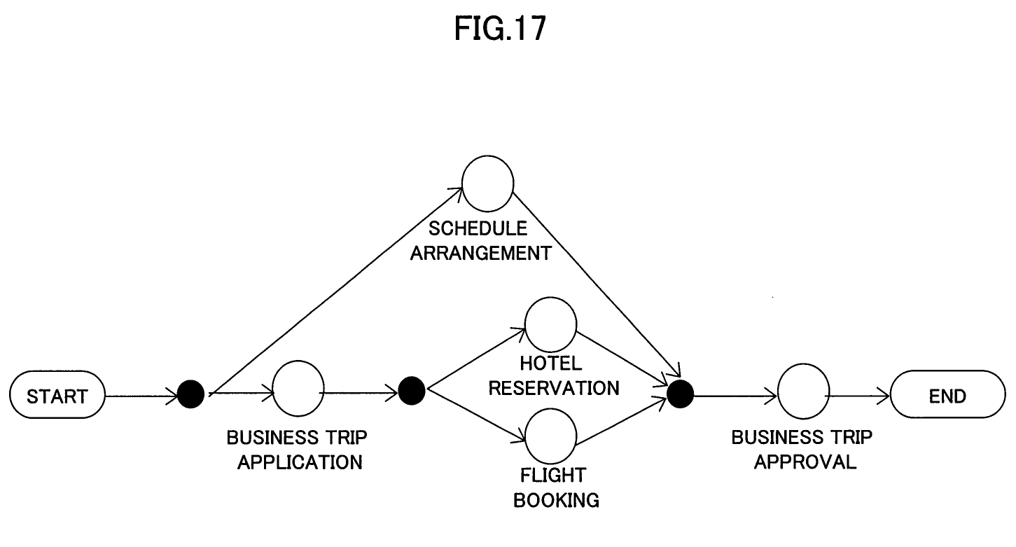

FIG. 17 is a diagram illustrating the reconfigured flow.

For instance, the process definition management part 22 enters a reconfigured flow as illustrated in FIG. 17 in the process definition database 23 as a reconfigured process definition.

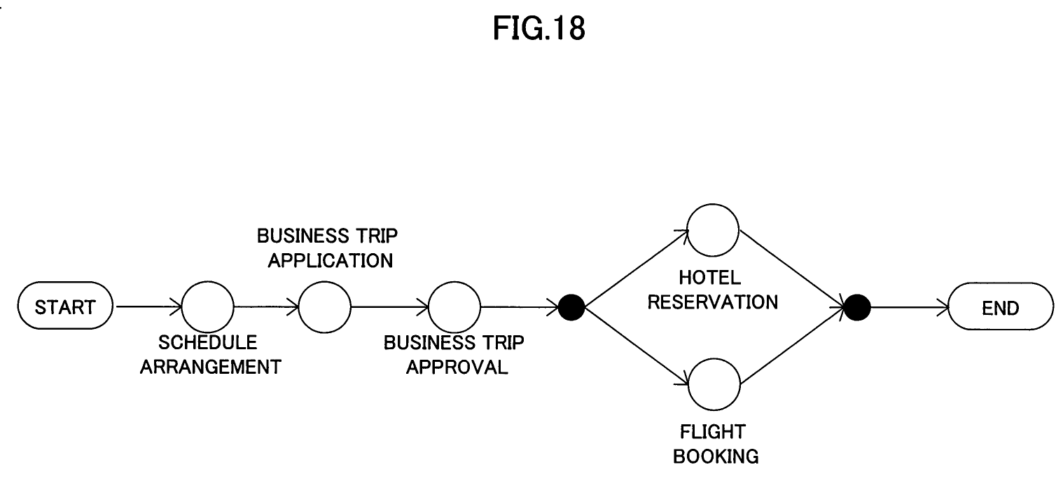

A description is given, with reference to FIGS. 18 through 23, of combining of multiple process definitions. FIG. 18 is a diagram illustrating a flow defined in a process definition.

According to the flow of FIG. 18, after arranging a schedule, applying for a business trip, and receiving approval of the business trip, hotel reservation and flight booking are performed in parallel.

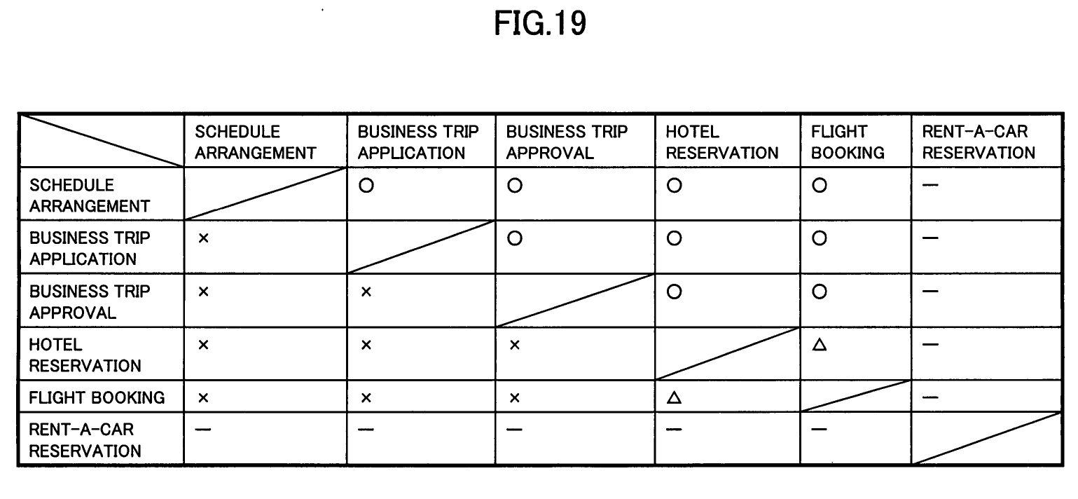

FIG. 19 illustrates an activity order relation table created by the process definition management part 22 based on the flow illustrated in FIG. 18.

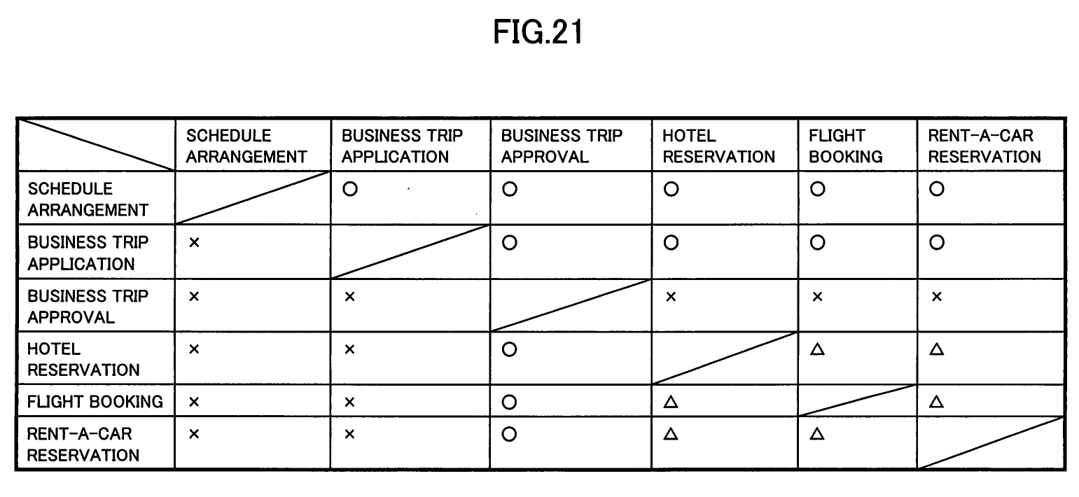

The table of FIG. 19 additionally includes the item of RENT-A-CAR RESERVATION in order to facilitate comparison with the below-described activity order relation table of FIG. 21.

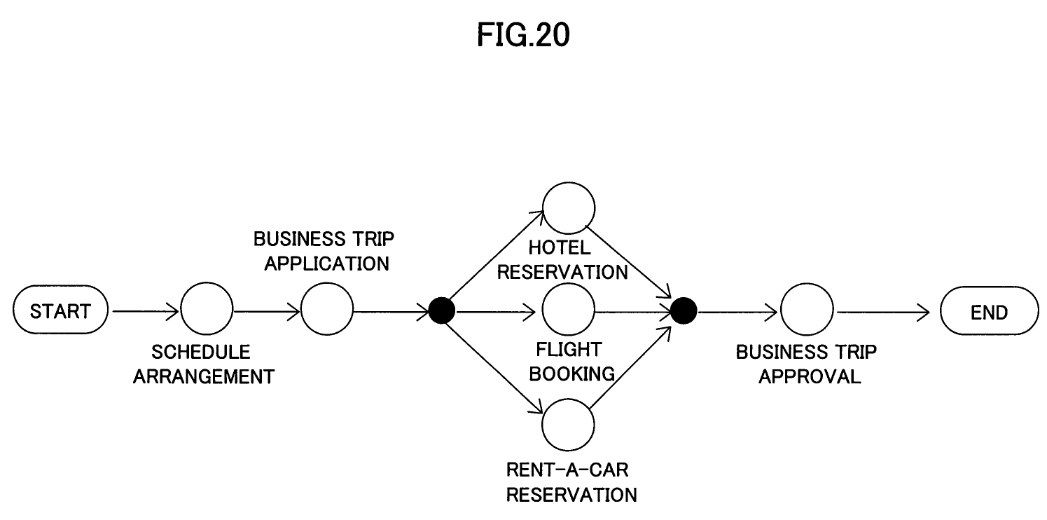

A description is given below, with reference to FIG. 20, of a flow defined in another process definition. FIG. 20 is a diagram illustrating a flow defined in another process definition.

According to the flow of FIG. 20, hotel reservation, flight booking, and rent-a-car reservation are performed in parallel after arranging a schedule and applying for a business trip, and thereafter, the business trip is to be approved.

FIG. 21 illustrates an activity order relation table created by the process definition management part 22 based on the flow illustrated in FIG. 20.

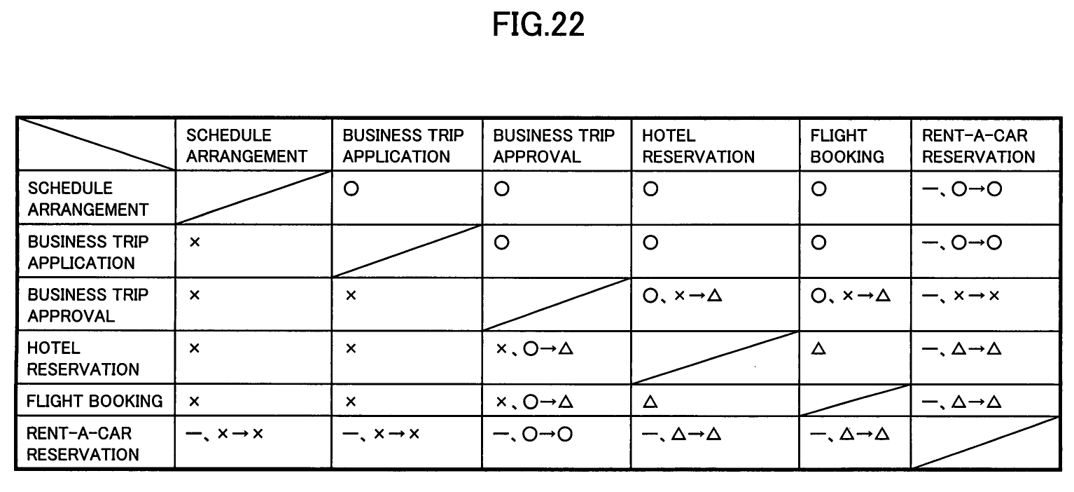

FIG. 22 illustrates an activity order relation table created by the process definition management part 22 based on the activity order relation tables of FIGS. 19 and 21.

The process definition management part 22 compares the activity order relation table of FIG. 19 created based on a flow defined by a process definition and the activity order relation table of FIG. 21 created based on a flow defined by another process definition, and with respect to any two activities whose order relation differs between the tables of FIGS. 19 and 21, the process definition management part 22 sets NO DEPENDENCY (triangle) as the data on their order relation as illustrated in FIG. 22.

Further, when the flows have different activity configurations, the process definition management part 22 creates the table using only the existing relationship between activities.

Based on the created activity order relation table illustrated in FIG. 22, the process definition management part 22 combines activities having no order relation by AND-Split or AND-Join, and connects activities having an order relation with a normal transition, thereby reconfiguring the flow.

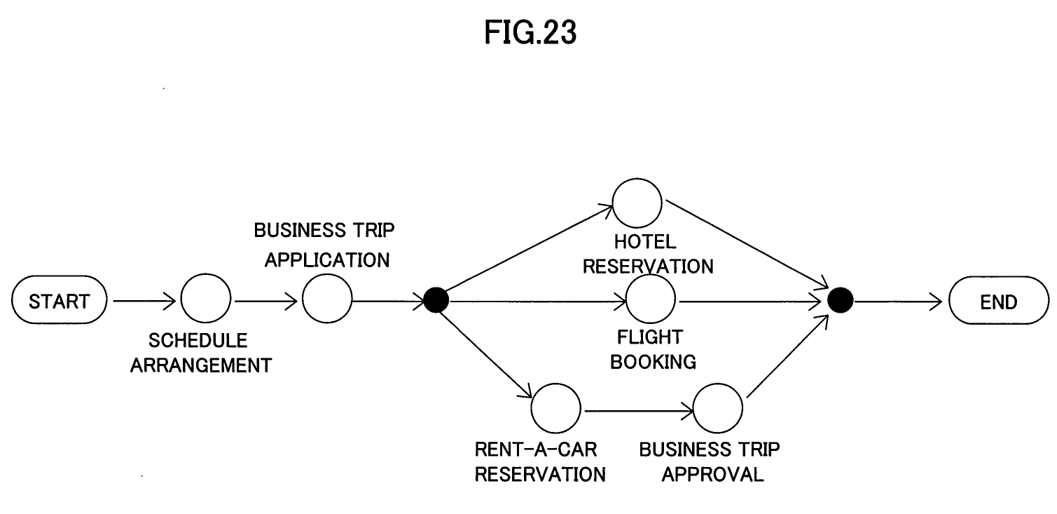

FIG. 23 is a diagram illustrating the reconfigured flow.

For instance, the process definition management part 22 enters a reconfigured flow as illustrated in FIG. 22 in the process definition database 23 as a reconfigured process definition.

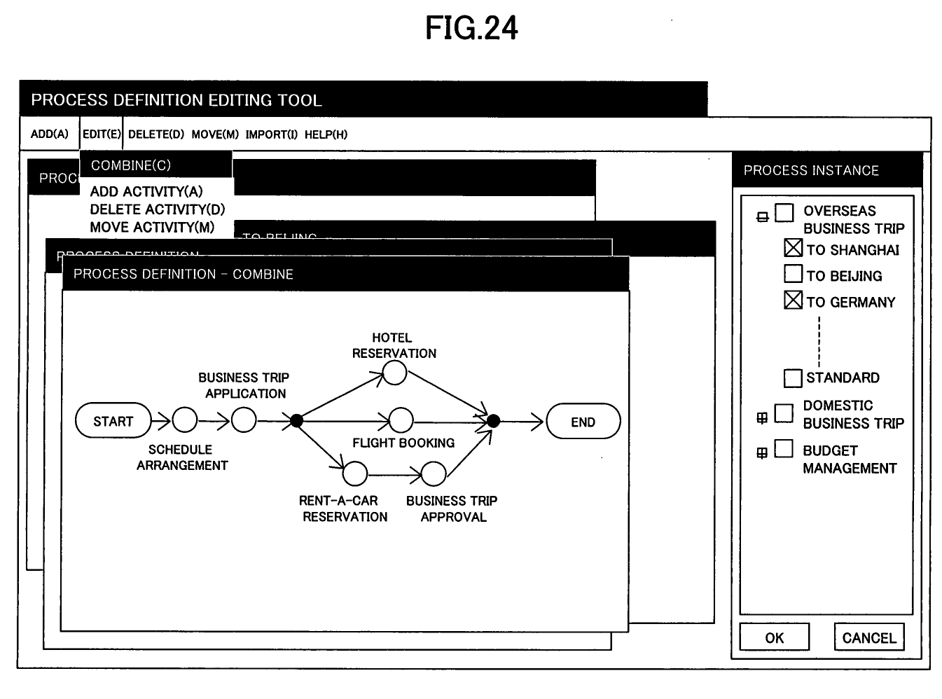

A description is given below, with reference to FIG. 24, of a GUI (Graphical User Interface) in the process definition editing tool 21. FIG. 24 is a diagram illustrating a GUI in the process definition editing tool 21.

Either the process definition management part 22 or the process definition editing tool 21 may combine process definitions by performing processing as described with reference to FIGS. 18 through 23 as a result of a user selecting COMBINE of EDIT using the process definition editing tool 21 as illustrated in FIG. 24.

### Second Embodiment

In the above-described first embodiment, the cases where activity order relation tables are created from constraints on the order relations between activities such as a base flow and a process execution result Gantt chart are illustrated. In the following, a case where an activity order relation table is created based on other dependency such as the dependency between the product of a process or activity and the activity. In the second embodiment, a description is given of the differences from the first embodiment.

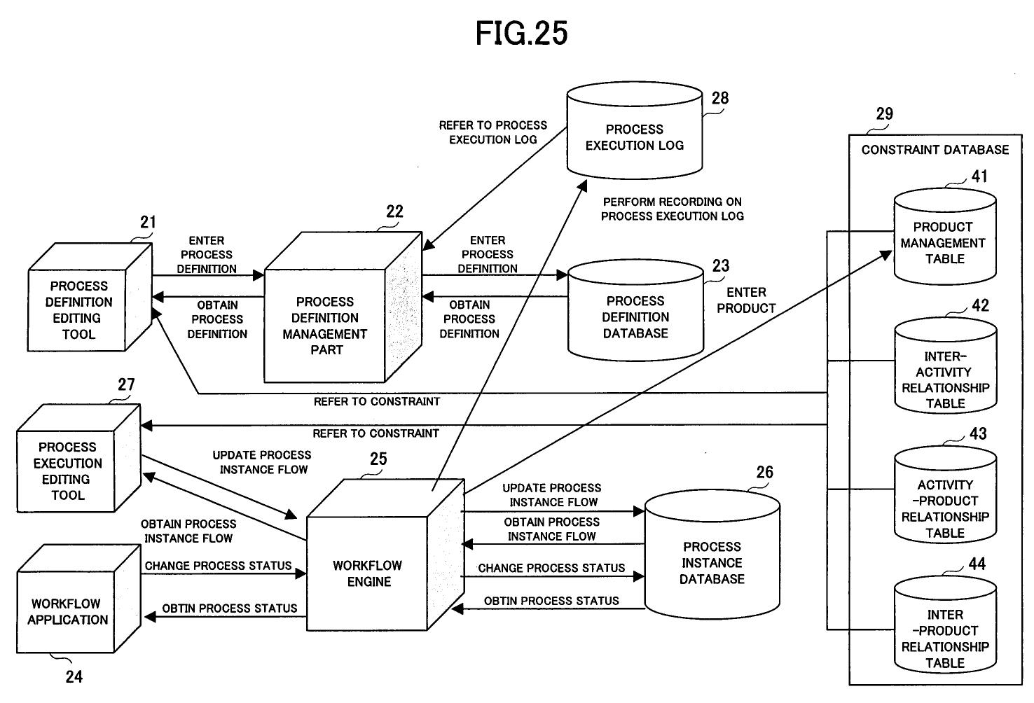

A description is given below, with reference to FIG. 25, of a configuration of software installed in the server 1 and the client 3 according to the second embodiment of the present invention. FIG. 25 is a schematic diagram illustrating a software configuration according to the second embodiment of the present invention.

The software configuration illustrated in FIG. 25 includes the process definition editing tool 21, the workflow application 24, the process execution editing tool 27, the process definition management part 22, the workflow engine 25, the process definition database 23, the process instance database 26, the process execution log 28, and a constraint database 29.

The process definition editing tool 21 defines a process. Based on a request from a user to define a process or edit a process definition, the process definition editing tool 21 provides the user with assistance in defining the process or editing the process definition, referring to a constraint stored in the constraint database 29. The process definition editing tool 21 also enters the edited or newly created process definition in the process definition database 23 through the process definition management part 22, and obtains a process definition from the process definition database 23 through the process definition management part 22. The term “user” refers to, for instance, a workflow participant. FIG. 25 illustrates that the process definition editing tool 21 directly refers to a constraint stored in the constraint database 29. Alternatively, for instance, the process definition editing tool 21 may refer to a constraint stored in the constraint database 29 through the process definition management part 22. The same holds true for the following.

The workflow engine 25 enters a product as the result of, for instance, an activity or process in a product management table 41 of the constraint database 29 in response to a request from the workflow application 24.

The process execution editing tool 27 edits a process. The process execution editing tool 27 obtains a process instance flow from the process instance database 26 through the workflow engine 25. Based on a request from a user to edit a process instance flow (or a process), the process execution editing tool 27 provides the user with assistance in editing the process instance flow (or process), referring to a constraint stored in the constraint database 29. The process execution editing tool 27 stores the process instance flow (or process) reflecting the editing performed by the user in the process instance database 26 through the workflow engine 25, thereby updating the process instance flow (or process). FIG. 25 illustrates that the process execution editing tool 27 directly refers to a constraint stored in the constraint database 29. Alternatively, for instance, the process execution editing tool 27 may refer to a constraint stored in the constraint database 29 through the process definition management part 22. The same holds true for the following.

The constraint database 29 stores constraints. The constraint database 29 includes the product management table 41, an inter-activity relationship table 42, an activity-product relationship table 43, and an inter-product relationship table 44. The product management table 41 manages a product as the result of an activity or process. The inter-activity relationship table 42 retains the relationship between activities. The activity-product relationship table 43 retains the relationship between an activity and a product as the result of the activity or a process. The inter-product relationship table 44 retains the relationship between products as the results of activities or processes. The constraint database 29 may further include the activity order relation table illustrated in the first embodiment.

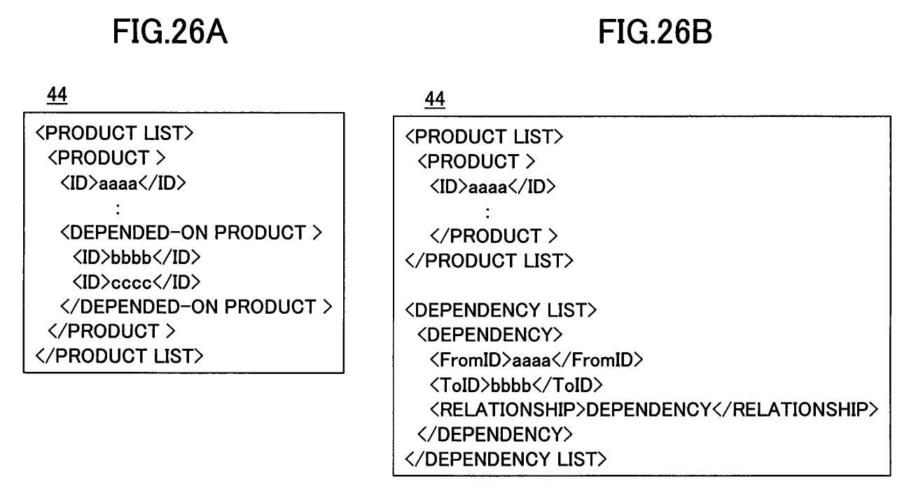

FIGS. 26A and 26B illustrate examples of the inter-product relationship table 44 stored in the constraint database 29.

The example of FIG. 26A expresses the relationship between products by inclusion relation. The example of FIG. 26B expresses the relationship between products by dependency.

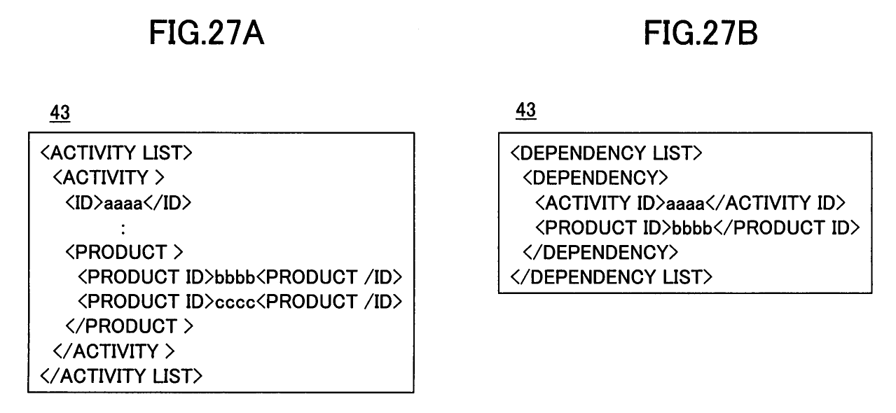

FIGS. 27A and 27B illustrate examples of the activity-product relationship table 43 stored in the constraint database 29.

The example of FIG. 27A expresses the relationship between an activity and a product by inclusion relation. The example of FIG. 27B expresses the relationship between an activity and a product by inclusion relation.

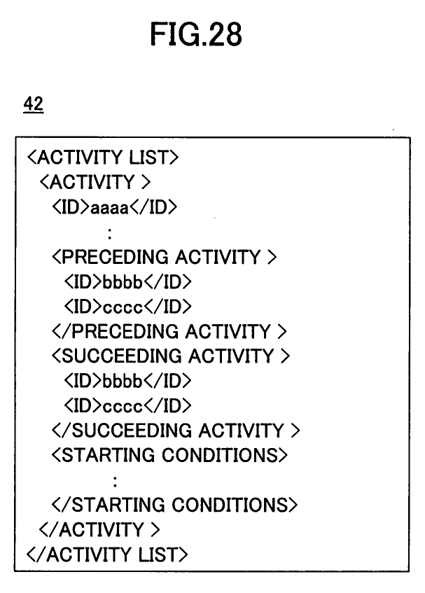

FIG. 28 illustrates an example of the inter-activity relationship table 42 stored in the constraint database 29.

As illustrated in FIG. 28, the inter-activity relationship table 42 includes the order relation between activities (such as preceding or succeeding) and starting conditions (such as parameters and conditions).

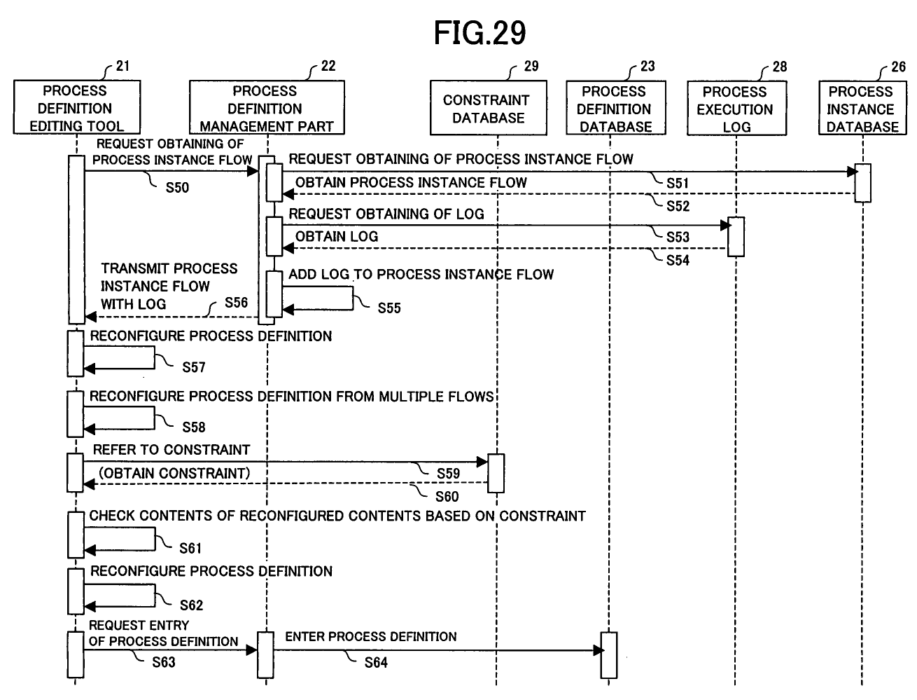

A description is given below, with reference to FIG. 29, of reconfiguration of a process definition according to the second embodiment. FIG. 29 is a sequence diagram illustrating reconfiguration of a process definition.

First, in step S50, the process definition editing tool 21 transmits a request to obtain a process instance flow to the process definition management part 22 based on a request from a user.

In step S51, receiving the request from the process definition editing tool 21, the process definition management part 22 requests the process instance database 26 to obtain the process instance flow, and in step S52, the process definition management part 22 obtains the process instance flow.

In step S53, the process definition management part 22 requests the process execution log 28 to obtain a log, and in step S54, the process definition management part 22 obtains the log.

Obtaining the process instance flow and the log, in step S55, the process definition management part 22 adds the log to the process instance flow, and in step S56, the process definition management part 22 transmits the process instance flow with the log to the process definition editing tool 21.

In step S57, the process definition editing tool 21 reconfigures a process definition based on the process instance flow to which the log is added. Alternatively, in the case where multiple process instance flows are obtained and transmitted, in step S58, the process definition editing tool 21 reconfigures a process definition based on the multiple process instance flows. It is sufficient to perform either step S57 or step S58.

In steps S59 and 60, the process definition editing tool 21 refers to a constraint stored in the constraint database 29 based on the contents of the reconfigured process definition, such as an activity included in the reconfigured process definition. Here, the term “refer” means to search for a constraint stored in the constraint database 29 based on, for instance, the contents of the reconfigured process definition and obtain the result of the search.

In step S61, the process definition editing tool 21 checks the contents of the reconfigured process definition based on the result of the reference. For instance, if the result of the check shows that the contents of the reconfigured process definition (such as the order of activities) do not comply with the constraint, in step S62, the process definition editing tool 21 reconfigures (or corrects) the process definition based on the constraint.

In step S63, the process definition editing tool 21 transmits a request to enter the reconfigured process definition to the process definition management part 22, the request including the reconfigured process definition.

In step S64, receiving the request from the process definition editing tool 21, the process definition management part 22 enters the reconfigured process definition in the process definition database 23.

By performing processing as illustrated in FIG. 29, it is possible to reconfigure a process definition, considering a constraint, and enter the reconfigured process definition. Further, by performing processing as illustrated in FIG. 29, it is possible to prevent a process definition from being reconfigured in a manner that does not comply with a constraint. FIG. 29 illustrates a case where the process definition editing tool 21 reconfigures a process definition and checks the contents of the reconfigured process definition referring to a constraint. However, this processing may be performed by the process definition management part 22 receiving a request from the process definition editing tool 21. For simplification, the following description is given, unless otherwise specified, based on the assumption that the process definition management part 22 performs processing such as reconfiguration of a process definition, reference to a constraint, and checking of the contents of the reconfigured process definition, which does not limit the implementation of the present invention.

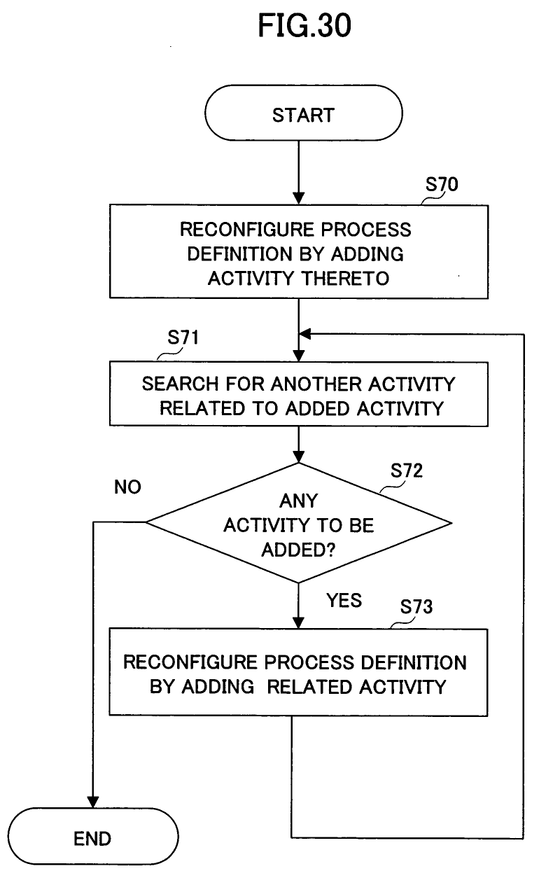

A description is given below, with reference to FIG. 30, of reconfiguration of a process definition based on the relationship between activities. FIG. 30 is a flowchart for illustrating reconfiguration of a process definition based on the relationship between activities.

In step S70, the process definition management part 22 reconfigures a process definition by adding an activity to the process definition based on, for instance, a log. The operation of step S70 corresponds to, for instance, that of step S57 of FIG. 29.

Next, in step S71, the process definition management part 22 searches the constraint database 29 for another activity related to the activity added to the process definition in step S70. The operation of step S71 corresponds to, for instance, those of steps S59 and S60 of FIG. 29.

Next, in step S72, the process definition management part 22 determines based on the result of the search of step S71 whether there is an activity to be added to the process definition in relation to the activity added thereto in step S70. The operation of step S72 corresponds to, for instance, that of step S61 of FIG. 29.

If the process definition management part 22 determines that there is an activity to be added to the process definition (YES in step S72), the process definition management part 22 proceeds to step S73. If the process definition management part 22 determines that there is no activity to be added to the process definition (NO in step S72), the process definition management part 22 ends the processing.

In step S73, the process definition management part 22 adds the activity related to the activity added to the process definition in step S70 to the process definition, thereby reconfiguring the process definition. Then, the process definition management part 22 returns to step S71. The operation of step S73 corresponds to, for instance, that of step S62 of FIG. 29.

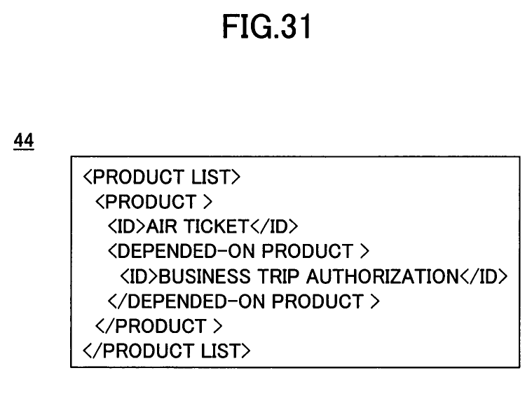

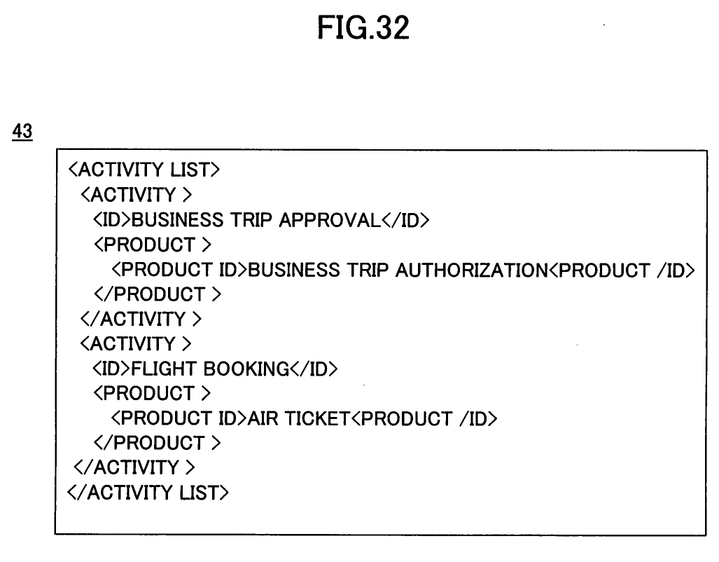

A description is given below of a case where, for instance, the process definition management part 22 creates the inter-activity relationship table 42 from the inter-product relationship table 44 and the activity-product relationship table 43. FIG. 31 illustrates another example of the inter-product relationship table 44. FIG. 32 illustrates another example of the activity-product relationship table 43.

For instance, a case where the inter-product relationship table 44 and the activity-product relationship table 43 as illustrated in FIGS. 31 and 32, respectively, are defined in the server 1 is assumed. In FIG. 31, the relationship between products is expressed by inclusion relation. In FIG. 32, the relationship between an activity and a product is expressed by inclusion relation.

For instance, the process definition management part 22 searches the inter-product relationship table 44 as illustrated in FIG. 31 based on a product AIR TICKET, and obtains information to the effect that the product AIR TICKET has dependence on a product BUSINESS TRIP AUTHORIZATION. Next, the process definition management part 22 searches the activity-product relationship table 43 as illustrated in FIG. 32 based on the product AIR TICKET, and obtains information to the effect that the product AIR TICKET has dependence on an activity FLIGHT BOOKING. Likewise, the process definition management part 22 searches the activity-product relationship table 43 as illustrated in FIG. 32 based on the product BUSINESS TRIP AUTHORIZATION, and obtains information to the effect that the product BUSINESS TRIP AUTHORIZATION has dependence on an activity BUSINESS TRIP APPROVAL.

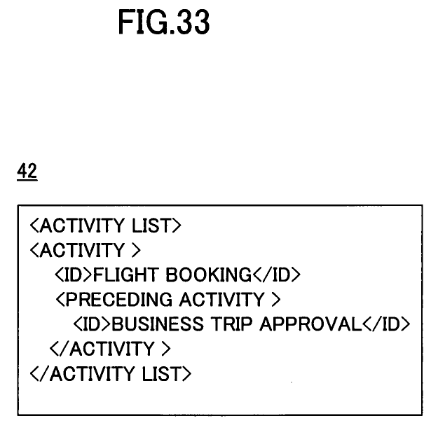

The process definition management part 22 generates the activity order relation of BUSINESS TRIP APPROVAL→FLIGHT BOOKING based on the obtained information, and creates the inter-activity relationship table 42 as illustrated in FIG. 33. FIG. 33 illustrates another example of the inter-activity relationship table 42. Thus, the process definition management part 22 can create the inter-activity relationship table 42 based on the inter-product relationship table 44 and the activity-product relationship table 43.

If multiple activities are related to a product, in some cases, the inter-product relationship table 44 or the activity-product relationship table 43 can describe their relationship more simply than the inter-activity relationship table 42.

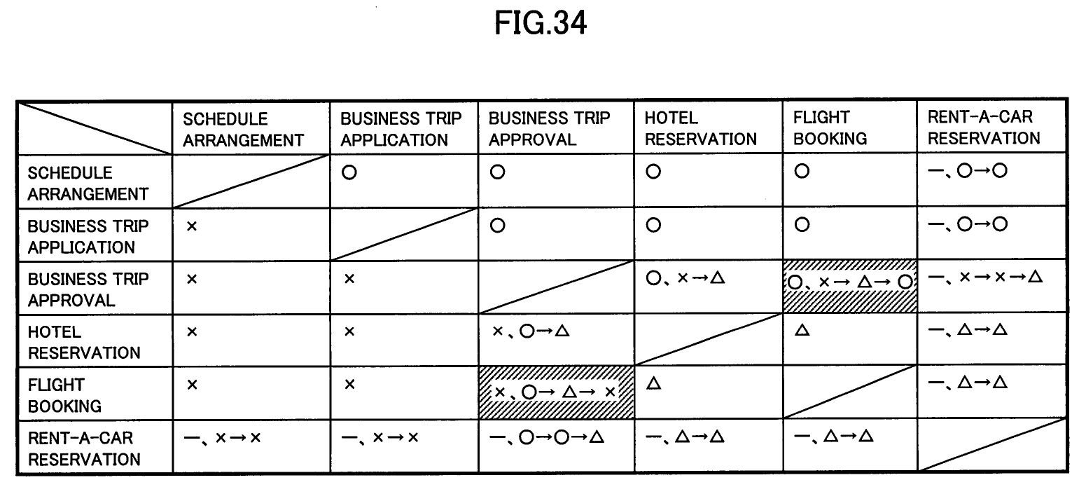

FIG. 34 illustrates an activity order relation table created by, for instance, the process definition management part 22 based on the activity order relation table illustrated in FIG. 22 of the first embodiment and the inter-activity relationship table 42 of FIG. 33.

The process definition management part 22 creates an activity order relation table as illustrated in FIG. 34 based on the activity order relation table illustrated in FIG. 22 of the first embodiment and the inter-activity relationship table 42 of FIG. 33. That is, first, the process definition management part 22 corrects the activity order relation table of FIG. 22 as indicated by hatching in FIG. 34 based on information on the inter-activity dependency of BUSINESS TRIP APPROVAL→FLIGHT BOOKING represented by the inter-activity relationship table 42 illustrated in FIG. 33. On the other hand, in creating the activity order relation table illustrated in FIG. 22, the process definition management part 22 obtains information to the effect that there is the activity order relation of RENT-A-CAR RESERVATION→BUSINESS TRIP APPROVAL and information to the effect that there is no order relation between the activities RENT-A-CAR RESERVATION and FLIGHT BOOKING. As illustrated in FIG. 33, the process definition management part 22 can obtain information to the effect that there is no dependency defined between the activities RENT-A-CAR RESERVATION and BUSINESS TRIP APPROVAL from the inter-activity relationship table 42. Therefore, the process definition management part 22 determines that there is no dependency defined between the activities RENT-A-CAR RESERVATION and BUSINESS TRIP APPROVAL, and corrects the activity order relation table of FIG. 22 to create the activity order relation table illustrated in FIG. 34.

Based on the created activity order relation table illustrated in FIG. 34, the process definition management part 22 combines activities having no order relation by AND-Split or AND-Join, and connects activities having an order relation with a normal transition, thereby reconfiguring the flow.

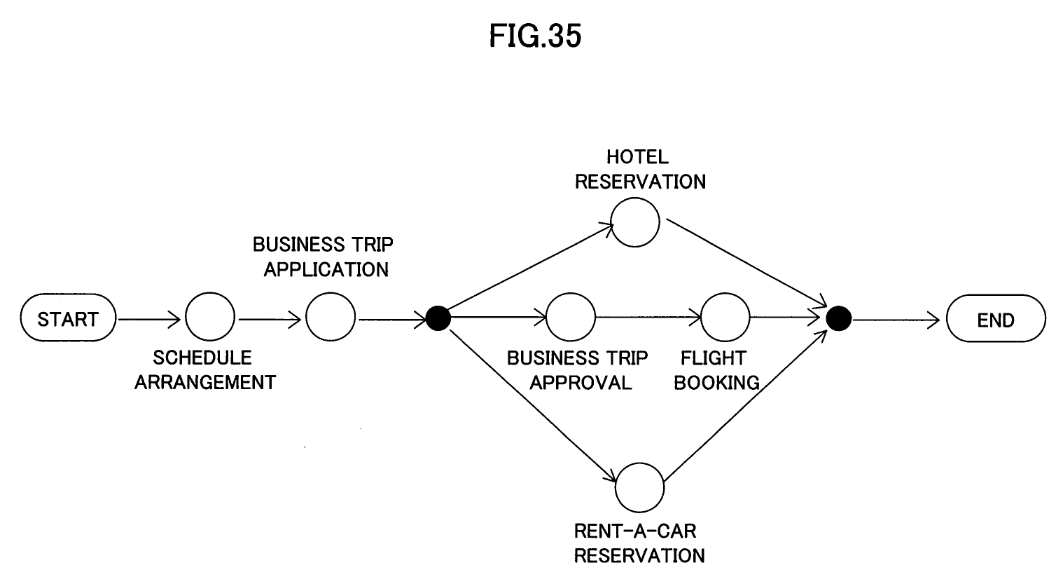

FIG. 35 is a diagram illustrating the reconfigured flow.

For instance, the process definition management part 22 enters a reconfigured flow as illustrated in FIG. 35 in the process definition database 23 as a reconfigured process definition.

As illustrated in FIGS. 34 and 35, the process definition management part 22 can reconfigure a process definition, considering the dependency between activities.

Thus, according to the present invention, it is possible to provide an optimized process definition. This effect is particularly effective in, for instance, a workflow system in which it is possible to edit a process while the process is being executed. The reason for this is as follows. In such a workflow system, a workflow participant can edit a process in execution with the result that there exist numerous flows as a result of process execution with respect to, for instance, tasks of the same kind. Therefore, it is difficult to create a process definition, which is a process template, reusing the flows.

The present invention is not limited to the specifically disclosed embodiments, and variations and modifications may be made without departing from the scope of the present invention.

The present application is based on Japanese Priority Patent Applications No. 2004-057681, filed on Mar. 2, 2004, and No. 2005-047792, filed on Feb. 23, 2005, the entire contents of which are hereby incorporated by reference.

1. A process management apparatus capable of editing a process, comprising:
a log recording part configured to record a result of execution of the process as a log; and
a process definition entering part configured to enter a process definition reconfigured based on the log, the process definition being a template of the process.

2. The process management apparatus as claimed in claim 1, wherein the process is editable during the execution thereof.

3. The process management apparatus as claimed in claim 1, wherein the log recording part records information on execution time of each of individual jobs of the process as the log.

4. The process management apparatus as claimed in claim 1, further comprising:
a reconfiguration part configured to reconfigure the process definition based on the log.

5. The process management apparatus as claimed in claim 4, wherein the reconfiguration part reconfigures the process definition based on the log and a constraint on an order relation between individual jobs of the process.

6. A process management apparatus capable of performing process editing, comprising:
a constraint information extracting part configured to extract constraint information from a plurality of process definitions, the process definitions being templates of corresponding processes, the constraint information being related to an order relation between individual jobs of each of the processes; and
a process definition entering part configured to enter one of the process definitions reconfigured based on the extracted constraint information.

7. The process management apparatus as claimed in claim 6, wherein the processes are editable during execution thereof.

8. The process management apparatus as claimed in claim 6, further comprising:
a reconfiguration part configured to reconfigure the process definitions based on the extracted constraint information.

9. An apparatus for editing a process, comprising:
a reconfiguration part configured to reconfigure a process definition based on a result of execution of the process, the process definition being a template of the process.

10. The apparatus as claimed in claim 9, wherein the process is editable during the execution thereof.

11. The apparatus as claimed in claim 9, wherein the result of the execution of the process is information on execution time of each of individual jobs of the process.

12. The apparatus as claimed in claim 9, wherein the reconfiguration part reconfigures the process definition based on the result of the execution of the process and a constraint on an order relation between individual jobs of the process.

13. The apparatus as claimed in claim 9, further comprising:
a display part configured to display a screen related to the reconfiguration of the process definition.

14. An apparatus for performing process editing, comprising:
a constraint information extracting part configured to extract constraint information from a plurality of process definitions, the process definitions being templates of corresponding processes, the constraint information being related to an order relation between individual jobs of each of the processes; and
a reconfiguration part configured to reconfigure the process definitions based on the extracted constraint information.

15. The apparatus as claimed in claim 14, wherein the processes are editable during execution thereof.

16. The apparatus as claimed in claim 14, further comprising:
a display part configured to display a screen related to the reconfiguration of the process definitions.

17. A computer-readable recording medium storing a program for causing a computer to execute a method of managing a process, the method comprising the steps of:
(a) recording a result of execution of the process as a log; and
(b) entering a process definition reconfigured based on the log, the process definition being a template of the process.

18. The computer-readable recording medium as claimed in claim 17, wherein said step (a) records the result of the execution of the process as the log, the process being edited during the execution thereof.

19. The computer-readable recording medium as claimed in claim 17, wherein said step (a) records information on execution time of each of individual jobs of the process as the log.

20. The computer-readable recording medium as claimed in claim 17, wherein the method further comprises the step of (c) reconfiguring the process definition based on the log.

21. The computer-readable recording medium as claimed in claim 20, wherein said step (c) reconfigures the process definition based on the log and a constraint on an order relation between individual jobs of the process.

22. A computer-readable recording medium storing a program for causing a computer to execute a process management method, the process management method comprising the steps of:
(a) extracting constraint information from a plurality of process definitions, the process definitions being templates of corresponding processes, the constraint information being related to an order relation between individual jobs of each of the processes; and
(b) entering one of the process definitions reconfigured based on the extracted constraint information.

23. The computer-readable recording medium as claimed in claim 22, wherein the process management method further comprises the step of (c) reconfiguring the process definitions based on the extracted constraint information.

24. A computer-readable recording medium storing a program for causing a computer to execute a method of editing a process, the method comprising the step of:
(a) reconfiguring a process definition based on a result of execution of the process, the process definition being a template of the process.

25. The computer-readable recording medium as claimed in claim 24, wherein said step (a) reconfigures the process definition based on the result of the execution of the process, the process being edited during the execution thereof.

26. The computer-readable recording medium as claimed in claim 24, wherein the result of the execution of the process is information on execution time of each of individual jobs of the process.

27. The computer-readable recording medium as claimed in claim 24, wherein said step (a) reconfigures the process definition based on the result of the execution of the process and a constraint on an order relation between individual jobs of the process.

28. The computer-readable recording medium as claimed in claim 24, wherein the method further comprises the step of (b) displaying a screen related to the reconfiguration of the process definition.

29. A computer-readable recording medium storing a program for causing a computer to execute a process editing method, the process editing method comprising the steps of:
(a) extracting constraint information from a plurality of process definitions, the process definitions being templates of corresponding processes, the constraint information being related to an order relation between individual jobs of each of the processes; and
(b) reconfiguring the process definitions based on the extracted constraint information.

30. The computer-readable recording medium as claimed in claim 29, wherein the process editing method further comprises the step of (c) displaying a screen related to the reconfiguration of the process definitions.

31. A method of managing a process, the method comprising the steps of:
(a) recording a result of execution of the process as a log; and
(b) entering a process definition reconfigured based on the log, the process definition being a template of the process.

32. A process management method, comprising the steps of:
(a) extracting constraint information from a plurality of process definitions, the process definitions being templates of corresponding processes, the constraint information being related to an order relation between individual jobs of each of the processes; and
(b) entering one of the process definitions reconfigured based on the extracted constraint information.

33. A method of editing a process, comprising the step of:
reconfiguring a process definition based on a result of execution of the process, the process definition being a template of the process.

34. A process editing method, comprising the steps of:
(a) extracting constraint information from a plurality of process definitions, the process definitions being templates of corresponding processes, the constraint information being related to an order relation between individual jobs of each of the processes; and
(b) reconfiguring the process definitions based on the extracted constraint information.
